(19) United States
(12) Patent Application Publication
(10) Pub. No.: US 2024/0134973 A1
(43) Pub. Date: Apr. 25, 2024

(54) PROTECTION OF MASKED DATA

(71) Applicant: STMICROELECTRONICS (ROUSSET) SAS, Rousset (FR)

(72) Inventor: Thomas SARNO, Fuveau (FR)

(73) Assignee: STMICROELECTRONICS (ROUSSET) SAS, Rousset (FR)

(21) Appl. No.: 18/487,697

(22) Filed: Oct. 15, 2023

(30) Foreign Application Priority Data
Oct. 24, 2022 (FR) 2211078

(51) Int. Cl. G06F 21/55

(52) U.S. Cl. CPC G06F 21/554; G06F 2221/034

(57) ABSTRACT

A device includes a memory and cryptographic processing circuitry coupled to the memory. The memory, in operation, stores one or more lookup tables. The cryptographic processing circuitry, in operation, processes masked data and protects the processing of masked data against side channel attacks. The protecting includes applying masked binary logic operations to masked data using lookup tables of the one or more lookup tables.

### BACKGROUND

### Technical Field

The present disclosure generally concerns electronic devices and circuits, and in particular electronic devices and circuits adapted to processing binary data. The present disclosure more precisely relates to the protection of binary data and, in particular, to the protection of binary data against attacks by side channel analysis.

### Description of the Related Art

During the use of binary data, it is current to use masking operations and masked logic operations to protect the data. Such operations may be implemented, for example, by a processor. Typical practical applications where data needs to be protected might include applications executed by smart cards, smartphones, tablets, etc.

### BRIEF SUMMARY

In an embodiment, a method comprises: processing first masked data; and protecting the first masked data against side channel attacks during the processing of the first masked data. The protect includes: applying, using a lookup table, a masked binary logic operation to the first masked data.

In an embodiment, a device comprises a memory and cryptographic processing circuitry coupled to the memory. The memory, in operation, stores one or more lookup tables. The cryptographic processing circuitry, in operation processes masked data and protects the processing of masked data against side channel attacks. The protecting includes applying masked binary logic operations to masked data using lookup tables of the one or more lookup tables.

In an embodiment, a system comprises a host processor, and cryptographic processing circuitry coupled to the host processor. The cryptographic processing circuitry, in operation, processes masked data and protects the processing of masked data against side channel attacks. The protecting includes applying masked binary logic operations to masked data using one or more lookup tables.

In an embodiment, a non-transitory computer-readable medium's contents configure cryptographic processing circuitry to perform a method. The method comprises processing masked data and protecting the processing of masked data against side channel attacks. The protecting includes applying masked binary logic operations to masked data using one or more lookup tables.

### BRIEF DESCRIPTION OF THE SEVERAL VIEWS OF THE DRAWINGS

The foregoing features and advantages, as well as others, will be described in detail in the rest of the disclosure of specific embodiments given by way of illustration and not limitation with reference to the accompanying drawings, in which:

FIG. 1 very schematically shows in the form of blocks an electronic device to which the embodiment described in relation with FIG. 6 may apply;

FIG. 2 very schematically shows in the form of blocks a masking operation;

FIG. 3 very schematically shows in the form of blocks a masked binary logic operation;

FIG. 4 comprises two views illustrating a first implementation of a masked binary logic operation;

FIG. 5 comprises two views illustrating a second implementation of a masked binary logic operation; and

FIG. 6 very schematically shows in the form of blocks an implementation mode of a method of protection against side channel attacks.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, no detailed example of a masked data processing method is described, the described embodiments being compatible with most known masked data processing methods.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

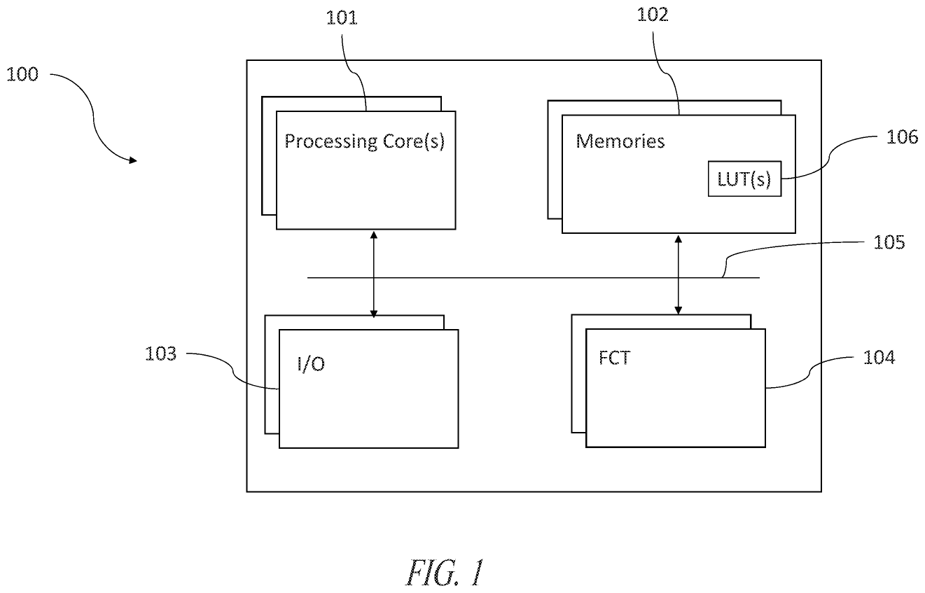

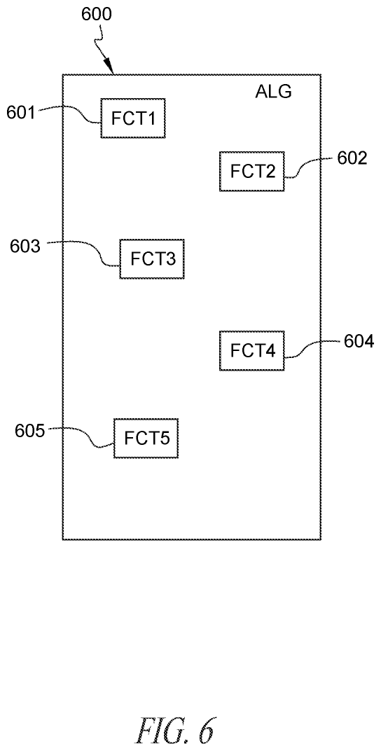

In the following disclosure, when reference is made to absolute positional qualifiers, such as the terms “front,” “back,” “top,” “bottom,” “left,” “right,” etc., or to relative positional qualifiers, such as the terms “above,” “below,” “upper,” “lower,” etc., or to qualifiers of orientation, such as “horizontal,” “vertical,” etc., reference is made, unless specified otherwise, to the orientation of the figures. FIG. 1 very schematically shows in the form of blocks an electronic device 100 capable of implementing the implementation mode of a method of protection against side channel attacks described in relation with FIG. 6.

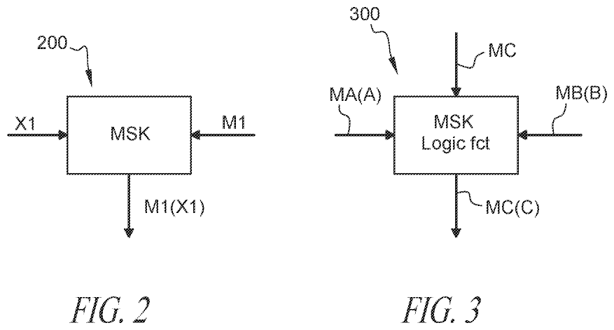

Device 100 is an electronic device adapted to processing data, and more particularly, to processing secret data, that is, data, the access to which is restricted to one or a plurality of specific persons or devices. For this purpose, device 100 is adapted to processing masked data, that is, ciphered data. A masking operation is described in relation with FIG. 2. Device 100 is further adapted to implementing masked binary logic operations. A masked binary logic operation is described in relation with FIG. 3.

Device 100 comprises one or more processors 101 (CPU) or processing cores, which, in operation, process data. According to an example, device 100 may comprise a plurality of processors or processing cores, each adapted to processing different types of data. According to a specific example, device 100 may comprise a main processor which in operation processes data associated with a first protection level (e.g., data which does not need to be kept secret) and a secure processor, which, in operation processes data associated with a second protection level (e.g., secret data).

Device 100 further comprises one or a plurality of memories 102 (MEM) into which are stored data, for example, binary data. According to an example, device 100 comprises a plurality of types of memories, such as a ROM, a volatile memory, and/or a non-volatile memory. According to a specific example, device 100 may comprise a main memory and at least one secure memory adapted to storing secret data.

Device 100 further and optionally comprises one or a plurality of input/output circuits 103 (I/O) enabling device 100 to transmit and/or to receive data and/or energy with one or a plurality of external electronic devices.

Device 100 further comprises one or a plurality of circuits 104 (FCT) implementing one or a plurality of functionalities of device 100. According to an example, circuits 104 may comprise specific data processing circuits, such as ciphering circuits, or circuits enabling to perform measurements, such as sensors.

Device 100 further comprises one or a plurality of communication buses 105 enabling all the circuits of device 100 to communicate. In FIG. 1, a single bus 105 coupling processor 101, memory or memories 102, and circuits 103 and 104 is shown but in practice, device 100 typically may comprise a plurality of communication buses coupling these different elements.

As illustrated, the memory 102 comprises one or more lookup tables 106, which, in operation, facilitate protecting data from side channel attacks, as discussed in more detail herein.

Embodiments of the device 100 of FIG. 1 may include fewer components than illustrated, may include more components than illustrated, and may combine or separate components in various manners. For example, a processing core 101 may include one or more internal memories 102, which may store one or more of the one or more lookup tables 106.

FIG. 2 schematically shows in the form of blocks the implementation of an operation of masking 200 (MSK) of binary data X1 with a mask M1.

Masking operation 200 enables to perform a secure processing of a piece of data by combining it, or by ciphering it, with another binary piece of data called a mask. There exist different types of data masking, but in the example embodiments described hereafter, the masking used is a masking using a logic XOR-type operation. Other types of masking may be envisaged, such as multiplicative masking, and are within the abilities of those skilled in the art.

Thus, masking operation 200 implements a masking operation by, for example, using the following mathematical formula:

M1(X1)=X1 xor M1 [Math 1]

wherein:
operator xor designate the EXCLUSIVE OR logic operation;
X1 is the binary data to be masked;
M1 is the binary data used as a mask; and
M1(X1) is the masked binary data.

Further, an unmasking operation enabling to return data X1 from masked data M1(X1) and from mask M1 applies the same operation as a masking operation. Indeed, when the masking operation is a simple use of the XOR logic operation, masking masked data M1(X1) with mask M1 amounts to canceling the first operation. In other words, an unmasking operation uses the following mathematical formula:

X1=M1(X1)xor M1 [Math 2]

FIG. 3 schematically shows in the form of blocks an embodiment of a masked binary logic operation 300 (MSK Logic fct) of two masked data MA(A) and MB(B).

Masked data MA(A), respectively MB(B), are the result of the application of a masking operation to data A, respectively B, by using a mask MA, respectively MB.

The masked binary logic operation is a logic operation taking as an input one or a plurality of binary data, masked or not, and delivering as an output binary data masked with a mask independent from the possible masks of the binary input data. In FIG. 3, operation 300 takes, as an input, two masked binary data MA(A) and MB(B) and an output mask MC, and delivers as an output masked data MC(C). As a variant, operation 300 may take as an input a single binary piece of data, or more than two pieces of data.

Operation 300 is an operation adapted to successively implementing a binary logic operation F and a masking operation. More particularly, operation 300 implements the following mathematical formula:

MC(C)=[F(MA(A);MB(B))] xor MC [Math 3]

Function F is a binary logic function, that is, a function implementing a bitwise logic operation and taking, as an input, binary data. According to an embodiment, function F implements a selected operation from the group comprising: an inverter-type logic operation, an OR-type logic operation, a NOR-type logic operation, an XOR-type logic operation, an XNOR logic operation, a NOT-type logic operation, an AND-type logic operation, a NAND-type logic operation, a bitwise multiplication operation, any of the previous logic operations using one or a plurality of data stored in said logic operations, and a combination of two or more of the previous operations.

The masking operation is of the type of that described in relation with FIG. 2.

According to an example, operation 300 may take, as input data, data having at least 2 bits, for example, 2, 3, or 4 bits.

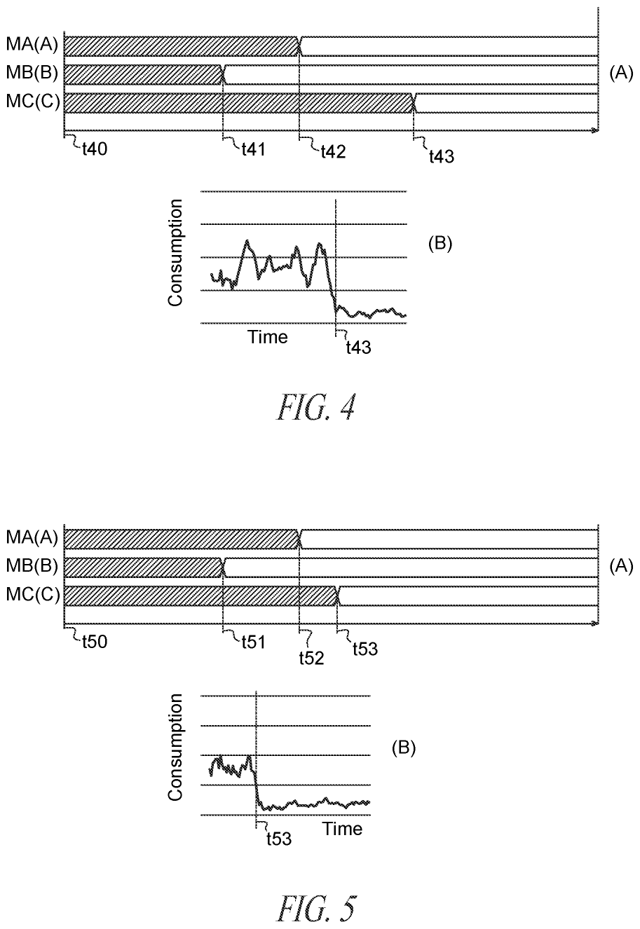

A known way of recovering masked secret data is to monitor the energy consumption of a device implementing operations on these data. An attack of this type is called attack by side-channel analysis. Indeed, the implementation of a masked binary logic operation may have an implementation time variable according to the data received as an input. In particular, certain data, such as data representing FIG. 0 in certain cases, may simplify the implementation of the calculations and thus accelerate the implementation time of the operation. This example is described in further detail in relation with FIGS. 4 and 5. Further, if data may simplify the implementation of an operation forming part of a processing method comprising a plurality of operations, then these data also accelerate the complete processing method.

FIGS. 4 and 5 each comprise two views illustrating the implementation of an attack by side channel analysis against the operation 300 described in relation with FIG. 3. More particularly, each FIG. 4, 5 comprises a view (A) showing a timing diagram illustrating the implementation of operation 300 and a view (B) showing the time variation of the energy consumption of the circuit implementing operation 300.

In the case of FIG. 4, operation 300 receives masked data MA(A) and MB(B) having values which do not simplify the implementation of operation 300.

At a time t40, operation 300 has not received masked data MA(A) and MB(B) yet, and cannot be implemented to deliver masked data MC(C). According to an example, masked data MB(B) are made accessible for operation 300 from a time t41, subsequent to time t40, and data MA(A) are made accessible for operation 300 from a time t42, subsequent to times t40 and t41. Operation 300 can thus only be implemented from time t42, and at a time t43, subsequent to time t42, the masked result data MC(C) are obtained and made accessible by the implementation of operation 300.

The graph of view (B) indicates that until time t43, the electric power consumption of the circuit implementing operation 300 is high, then decreases since the operation is not longer implemented.

In the case of FIG. 5, and by comparison with the case of FIG. 4, operation 300 receives masked data MA(A) and MB(B) having at least one of their values, for example, the value of data MB(B), simplifying the implementation of operation 300.

At a time t50, operation 300 has not received masked data MA(A) and MB(B) yet, and cannot be implemented to deliver masked data MC(C). According to an example, masked data MB(B) are made accessible for operation 300 from a time t51, subsequent to time t50, and data MA(A) are made accessible for operation 300 from a time t52, subsequent to times t50 and t51. Operation 300 can thus theoretically only be implemented from time t52. However, in practice, since data MB(B) simplify the implementation of operation 300, then operation 300 can be implemented from the time when data MB(B) are made accessible, and at a time t53, subsequent to time t51, masked result data MC(C) are obtained and made accessible by the implementation of operation 300, with a time shift with respect to the masked result data MC(C) obtained in FIG. 4.

The graph of view (B) indicates that until time t53, the electric power consumption of the circuit implementing operation 300 is high, then decreases since the operation is no longer implemented.

It is advantageous to notice that, in the case of FIG. 5, the value of masked data MB(B) simplifies the implementation of operation 300, the time for performing operation 300 is decreased, and thus the energy consumption of the circuit implementing operation 300 is clearly decreased.

FIG. 6 very schematically shows in the form of blocks an implementation mode of an embodiment of a method of protection against side channel attacks. More particularly, FIG. 6 shows a method 600 (ALG) of processing of secret data.

More particularly, method 600 comprises the implementation of at least one masked binary logic function of the type of the function 300 described in relation with FIG. 3. In FIG. 6, method 600 implements five masked binary logic operations 601 (FCT1), 602 (FCT2), 603 (FCT3), 604 (FCT4), and 605 (FCT5). Operations 601 to 605 may be each implemented once or a plurality of times, and in any order.

According to an embodiment, at least one of operations 601 to 605 is implemented by using a lookup table. A lookup table is a list of associations of values stored in a memory or in a portion of a memory.

An advantage of this embodiment is that whatever the masked data sent at the input of an operation, the time of implementation of the operation is always the same, and thus the energy consumption of the device implementing method 600. This enables to make an attack by side channel analysis more difficult. In practice, the use of a lookup table enables to decrease the propagation of a time shift obtained by simplification of an operation as compared to other operations. According to an example, when the input masked binary data comprise two bits, this embodiment enables to decrease by at least 50% the time shift propagation.

According to another embodiment, a plurality of operations 601 to 605 are implemented by using lookup tables. Increasing the number of lookup tables used to implement method 600 enables to increase the difficulty of carrying out an attack by side channel analysis.

Various embodiments and variants have been described. Those skilled in the art will understand that certain features of these various embodiments and variants may be combined, and other variants will occur to those skilled in the art.

Finally, the practical implementation of the described embodiments and variations is within the abilities of those skilled in the art based on the functional indications given hereabove.

Method of protection of an electronic device (100) against attacks by side channel analysis, wherein the electronic device (100) may be adapted to applying at least one first masked binary logic operation (300; 601, 602, 603, 604, 605) to first masked data (MA(A), MB(B)), wherein said at least one first operation (300; 601, 602, 603, 604, 605) is implemented by a lookup table.

Said at least one masked binary logic operation (300; 601, 602, 603, 604, 605) may be an operation adapted to successively implementing a binary logic operation (F) and a masking operation (200).

Said binary logic operation (F) may execute a bitwise calculation.

Said binary logic operation (F) may be selected from the group comprising: an inverter-type logic operation, an OR-type logic operation, a NOR-type logic operation, an XOR-type logic operation, an XNOR logic operation, a NOT-type logic operation, an AND-type logic operation, a NAND-type logic operation, a bitwise multiplication operation, and a combination of two or more of the previous operations.

Said masking operation (200) may be a logic operation where binary data are combined with a mask.

Said masking operation (200) may implement an XOR-type logic operation.

The first masked data may be a piece of data comprising at least 2 bits.

The first masked data may be a piece of data comprising at least 3 bits.

The first masked data may be a piece of data comprising at least 4 bits.

The electronic device (100) may be adapted to applying at least one second masked binary logic operation (300; 601, 602, 603, 604, 605) to second masked data, said at least one second operation (300; 601, 602, 603, 604, 605) being implemented by a lookup table.

Device (100) may be adapted to implementing the method.

In an embodiment, a method comprises: processing first masked data; and protecting the first masked data against side channel attacks during the processing of the first masked data, the protecting including: applying, using a lookup table, a masked binary logic operation to the first masked data. In an embodiment, the applying the masked binary logic operation comprises: performing a binary logic operation using the lookup table; and applying a mask to a result of the binary logic operation. In an embodiment, the binary logic operation is a bitwise calculation. In an embodiment, the binary logic operation includes: an inverter-type logic operation; an OR-type logic operation; a NOR-type logic operation; an XOR-type logic operation; an XNOR logic operation; a NOT-type logic operation; an AND-type logic operation; a NAND-type logic operation; a bitwise multiplication operation; or a combination of two or more operations. In an embodiment, the apply the mask comprises applying a logic operation to combine the result of the binary logic operation with a mask. In an embodiment, the applying the mask comprises applying an XOR-type logic operation. In an embodiment, the first masked data is a piece of data having at least 2 bits. In an embodiment, the first masked data is a piece of data having at least 3 bits. In an embodiment, the first masked data is a piece of data having at least 4 bits. In an embodiment, the method comprises: processing second masked data with the first masked data; and protecting the second masked data against side channel attacks during the processing of the first and second masked data, the protecting including: applying, using a lookup table, the masked binary logic operation to the first masked data and the second masked data. In an embodiment, the method comprises: processing second masked data; and protecting the second masked data against side channel attacks during the processing of the second masked data, the protecting including: applying, using a second lookup table, a second masked binary logic operation to the second masked data. In an embodiment, the second masked data is a result of the processing of the first masked data.

In an embodiment, a device comprises: a memory, which, in operation, stores one or more lookup tables; and cryptographic processing circuitry coupled to the memory, wherein the cryptographic processing circuitry, in operation: processes masked data; and protects the processing of masked data against side channel attacks, the protecting including applying masked binary logic operations to masked data using lookup tables of the one or more lookup tables. In an embodiment, applying a masked binary logic operation comprises: performing a binary logic operation using the lookup table; and applying a mask to a result of the binary logic operation. In an embodiment, the binary logic operation is a bitwise calculation. In an embodiment, the binary logic operation includes: an inverter-type logic operation; an OR-type logic operation; a NOR-type logic operation; an XOR-type logic operation; an XNOR logic operation; a NOT-type logic operation; an AND-type logic operation; a NAND-type logic operation; a bitwise multiplication operation; or a combination of two or more operations. In an embodiment, the apply the mask comprises applying a logic operation to combine the result of the binary logic operation with a mask. In an embodiment, the applying the mask comprises applying an XOR-type logic operation. In an embodiment, the masked data is a piece of data having at least 2 bits. In an embodiment, the processing masked data comprises processing first masked data and second masked data; and the protecting comprises applying a masked binary logic operation to the first masked data and the second masked data using a lookup table of the one or more lookup tables. In an embodiment, the processing masked data comprises processing first masked data and processing second masked data; and the protecting comprises: applying a first masked binary logic operation to the first masked data using a first lookup table of the one or more lookup tables; and applying a second masked binary logic operation to the second masked data using a second lookup table of the one or more lookup tables. In an embodiment, the second masked data is a result of the processing of the first masked data.

In an embodiment, a system comprises: a host processor; and cryptographic processing circuitry coupled to the host processor, wherein the cryptographic processing circuitry, in operation: processes masked data; and protects the processing of masked data against side channel attacks, the protecting including applying masked binary logic operations to masked data using one or more lookup tables. In an embodiment, cryptographic processing circuitry comprises a memory storing the one or more lookup tables. In an embodiment, the processing masked data comprises processing first masked data and second masked data; and the protecting comprises applying a masked binary logic operation to the first masked data and the second masked data using a lookup table of the one or more lookup tables.

In an embodiment, a non-transitory computer-readable medium's contents configure cryptographic processing circuitry to perform a method, the method comprising: processing masked data; and protecting the processing of masked data against side channel attacks, the protecting including applying masked binary logic operations to masked data using one or more lookup tables. In an embodiment, the contents comprise instructions and the method comprises executing the instructions using the cryptographic processing circuitry. In an embodiment, the processing masked data comprises processing first masked data and processing second masked data; and the protecting comprises: applying a first masked binary logic operation to the first masked data using a first lookup table of the one or more lookup tables; and applying a second masked binary logic operation to the second masked data using a second lookup table of the one or more lookup tables.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
processing first masked data; and
protecting the first masked data against side channel attacks during the processing of the first masked data, the protecting including:
applying, using a lookup table, a masked binary logic operation to the first masked data.

2. The method according to claim 1, wherein the applying the masked binary logic operation comprises:
performing a binary logic operation using the lookup table; and
applying a mask to a result of the binary logic operation.

3. The method according to claim 2, wherein the binary logic operation is a bitwise calculation.

4. The method according to claim 2, wherein the binary logic operation includes:
an inverter-type logic operation;
an OR-type logic operation;
a NOR-type logic operation;
an XOR-type logic operation;
an XNOR logic operation;
a NOT-type logic operation;
an AND-type logic operation;
a NAND-type logic operation;
a bitwise multiplication operation; or
a combination of two or more operations.

5. The method according to claim 2, wherein the apply the mask comprises applying a logic operation to combine the result of the binary logic operation with a mask.

6. The method according to claim 5, wherein the applying the mask comprises applying an XOR-type logic operation.

7. The method according to claim 1, wherein the first masked data is a piece of data having at least 2 bits.

8. The method according to claim 7, wherein the first masked data is a piece of data having at least 3 bits.

9. The method according to claim 8, wherein the first masked data is a piece of data having at least 4 bits.

10. The method according to claim 1, comprising:
processing second masked data with the first masked data; and
protecting the second masked data against side channel attacks during the processing of the first and second masked data, the protecting including:
applying, using a lookup table, the masked binary logic operation to the first masked data and the second masked data.

11. The method according to claim 1, comprising:
processing second masked data; and
protecting the second masked data against side channel attacks during the processing of the second masked data, the protecting including:
applying, using a second lookup table, a second masked binary logic operation to the second masked data.

12. The method according to claim 11, wherein the second masked data is a result of the processing of the first masked data.

13. A device, comprising:
a memory, which, in operation, stores one or more lookup tables; and
cryptographic processing circuitry coupled to the memory, wherein the cryptographic processing circuitry, in operation:
processes masked data; and
protects the processing of masked data against side channel attacks, the protecting including applying masked binary logic operations to masked data using lookup tables of the one or more lookup tables.

14. The device according to claim 13, wherein applying a masked binary logic operation comprises:
performing a binary logic operation using the lookup table; and
applying a mask to a result of the binary logic operation.

15. The device according to claim 14, wherein the binary logic operation is a bitwise calculation.

16. The device according to claim 14, wherein the binary logic operation includes:
an inverter-type logic operation;
an OR-type logic operation;
a NOR-type logic operation;
an XOR-type logic operation;
an XNOR logic operation;
a NOT-type logic operation;
an AND-type logic operation;
a NAND-type logic operation;
a bitwise multiplication operation; or
a combination of two or more operations.

17. The device according to claim 14, wherein the apply the mask comprises applying a logic operation to combine the result of the binary logic operation with a mask.

18. The device according to claim 17, wherein the applying the mask comprises applying an XOR-type logic operation.

19. The device according to claim 13, wherein the masked data is a piece of data having at least 2 bits.

20. The device according to claim 13, wherein,
the processing masked data comprises processing first masked data and second masked data; and
the protecting comprises applying a masked binary logic operation to the first masked data and the second masked data using a lookup table of the one or more lookup tables.

21. The device according to claim 13, wherein,
the processing masked data comprises processing first masked data and processing second masked data; and
the protecting comprises:
applying a first masked binary logic operation to the first masked data using a first lookup table of the one or more lookup tables; and
applying a second masked binary logic operation to the second masked data using a second lookup table of the one or more lookup tables.

22. The device according to claim 21, wherein the second masked data is a result of the processing of the first masked data.

23. A system, comprising:
a host processor; and
cryptographic processing circuitry coupled to the host processor, wherein the cryptographic processing circuitry, in operation:
processes masked data; and
protects the processing of masked data against side channel attacks, the protecting including applying masked binary logic operations to masked data using one or more lookup tables.

24. The system according to claim 23, wherein cryptographic processing circuitry comprises a memory storing the one or more lookup tables.

25. The system according to claim 23, wherein,
the processing masked data comprises processing first masked data and second masked data; and
the protecting comprises applying a masked binary logic operation to the first masked data and the second masked data using a lookup table of the one or more lookup tables.

26. A non-transitory computer-readable medium having contents which configure cryptographic processing circuitry to perform a method, the method comprising:
processing masked data; and
protecting the processing of masked data against side channel attacks, the protecting including applying masked binary logic operations to masked data using one or more lookup tables.

27. The non-transitory computer-readable medium of claim 26, wherein the contents comprise instructions and the method comprises executing the instructions using the cryptographic processing circuitry.

28. The non-transitory computer-readable medium of claim 26, wherein,
the processing masked data comprises processing first masked data and processing second masked data; and
the protecting comprises:
applying a first masked binary logic operation to the first masked data using a first lookup table of the one or more lookup tables; and
applying a second masked binary logic operation to the second masked data using a second lookup table of the one or more lookup tables.
